(19) United States
(12) Patent Application Publication
(10) Pub. No.: US 2004/0196900 A1
(43) Pub. Date: Oct. 7, 2004

(54) Apparatus and method for communicating moving picture mail using a transcoding operation

(76) Inventors: Chae-Whan Lim, Daegu (KR); Jeong-Wook Seo, Daegu (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/757,496

(22) Filed: Jan. 15, 2004

(30) Foreign Application Priority Data
Jan. 20, 2003 (KR) 2003-3768

(51) Int. Cl. H04B 1/66

(52) U.S. Cl. 375/240

(57) ABSTRACT

A method and apparatus for enabling a moving picture mail server to receive moving picture mail from a first mobile terminal and transmit the received moving picture mail to the second mobile terminal. A support codec of the first mobile terminal serving as a transmitting side is confirmed. A support codec of the second mobile terminal serving as a receiving side is confirmed. It is determined whether or not the support codecs of the first and second mobile terminals are compatible. If the support codecs of the first and second mobile terminals are compatible, the moving picture mail received from the first mobile terminal is transmitted to the second mobile terminal. On the other hand, if the support codecs of the first and second mobile terminals are incompatible, the moving picture mail received from the first mobile terminal is transcoded on the basis of the support codec of the second mobile terminal. The transcoded moving picture mail is transmitted to the second mobile terminal.

### PRIORITY

This application claims priority to an application entitled “APPARATUS AND METHOD FOR COMMUNICATING MOVING PICTURE MAIL USING TRANSCODING OPERATION”, filed in the Korean Intellectual Property Office on Jan. 20, 2003 and assigned Ser. No. 2003-3768, the contents of which are incorporated herein by reference.

### BACKGROUND OF THE INVENTION

1. Field of the Invention

The present invention relates to an apparatus and method for communicating moving picture mail, and more particularly to an apparatus and method for transcoding moving picture mail on the basis of image coding of a receiving side's mobile terminal and transmitting the transcoded moving picture mail to the receiving side's mobile terminal.

2. Description of the Related Art

Mobile terminals have recently developed into a structure capable of transmitting high-speed data as well as providing voice communication. In particular, mobile communication networks based upon an International Mobile Telecommunication-2000 (IMT 2000) standard can implement high-speed data communications as well as voice communications using the mobile terminals. Data processable in the mobile terminals can include image or picture data.

As the need for moving picture mail from communication carriers and consumers is increasing, services for providing the moving picture mail are being implemented. It is expected that the moving picture mail services will increase. When moving pictures are transmitted, an image compression problem due to a large amount of data can occur. Furthermore, when the moving pictures are transmitted or received by means of the mobile terminal, the image compression problem is substantial. Conventionally, moving-picture signal compression is based upon the Moving Picture Expert Group 4 (MPEG 4) standard. When moving picture signals are compressed, an MPEG 4-based compression technique can appropriately compress a large amount of data but requires a large number of million instructions per second (MIPS). Thus, it is difficult for the MPEG 4-based compression technique to be applied to ARM 7???-based mobile terminals.

When the above-described image compression method is used, an image can be processed only by software. However, a solution using a high image update rate cannot be provided. A mobile terminal equipped with an internal camera or an external camera has a liquid crystal display (LCD) and a codec for compressing image data of still pictures. The codec for compressing the image data of still pictures can be a Joint Photographic Expert Group (JPEG) codec. Camera phones equipped with the above-described components are used for providing broadband services such as IMT-2000 services. Thus, it is expected that the mobile terminal consecutively compresses moving picture signals through the JPEG codec to generate and display a semi-moving picture signal or transmit the semi-moving picture signal to another mobile terminal or a moving picture mail server through a network. It is expected that the mobile terminal will be able to receive moving picture signals from another mobile terminal or a moving picture mail server through the network to reproduce the received moving picture signals.

The conventional image signal coding method uses various image coding techniques such as JPEG coding, wavelet coding and MPEG coding. Here, the JPEG coding and wavelet coding techniques are still-picture coding methods, while the MPEG4 coding technique is a moving-picture coding method. When still-picture signals are consecutively coded, a semi-moving picture signal can be generated. Thus, it is assumed that the moving picture signal includes the semi-moving picture signal. If the mobile terminals use different image coding techniques, there is a problem in that moving picture mail cannot be communicated between the mobile terminals due to compatibility issues. For example, the mobile terminal equipped with a wavelet codec cannot reproduce the moving picture mail based upon the JPEG coded image data. Similarly, the mobile terminal equipped with the JPEG codec cannot produce the moving picture mail based upon the wavelet coded image data. Therefore, there is required a method for enabling moving picture mail to be transmitted between the mobile terminals equipped with different image codecs.

Furthermore, when the moving picture mail or semi-moving picture mail is communicated, a receiving side and a transmitting side determine a transmission rate for the moving picture mail prior to transmission. The transmitting or receiving side transmits or receives the moving picture mail at the determined transmission rate. A channel environment between the transmitting and receiving sides affects a transmission method, such that a cut-off phenomenon in received moving picture signals can occur. In this case, the receiving side will request that the transmitting side retransmit the moving picture signal, or will inappropriately reproduce the moving picture signals having the cut-off phenomenon.

### SUMMARY OF THE INVENTION

Therefore, the present invention has been made in view of the above problems, and it is an object of the present invention to provide an apparatus and method that can enable moving picture mail to be communicated between a moving picture mail server and a mobile terminal in a mobile communication network system.

It is another object of the present invention to provide an apparatus and method that can perform a transcoding operation for moving picture mail to be transmitted on the basis of an image coding method of a mobile terminal and transmit a result of the transcoding operation in a mobile communication network system.

It is another object of the present invention to provide an apparatus and method that can confirm an image coding method of a mobile terminal when a moving picture mail server transmits moving picture mail and perform a transcoding operation for the moving picture mail to transmit a result of the transcoding operation if the moving picture mail to be transmitted is incompatible.

It is another object of the present invention to provide an apparatus and method that can enable a moving picture mail server to transmit moving picture mail to a mobile terminal and vary a transmission rate of the moving picture mail according to reception state information transmitted from the mobile terminal.

It is yet another object of the present invention to provide an apparatus and method that can enable a mobile terminal to receive and reproduce moving picture mail transmitted from a moving picture mail server, and enable the mobile terminal to transmit reception state information to the moving picture mail server so that the moving picture mail server can determine a transmission rate of the moving picture mail based upon the reception state information in order to vary the transmission rate.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram illustrating the architecture of a network for transmitting moving picture mail in accordance with an embodiment of the present invention;

FIG. 2 is a block diagram illustrating components for communicating moving picture mail between mobile terminals, a moving picture mail server and a transcoding server in accordance with an embodiment of the present invention;

FIG. 3A is a block diagram illustrating a procedure for enabling one mobile terminal shown in FIG. 1 to transmit moving picture mail to the moving picture mail server shown in FIG. 1;

FIG. 3B is a block diagram illustrating a procedure for enabling the moving picture mail server shown in FIG. 1 to transmit received moving picture mail to the other mobile terminal shown in FIG. 1;

FIGS. 4A and 4B are block diagrams illustrating the formats of moving picture signals in accordance with an embodiment of the present invention;

FIGS. 5A through 5E are block diagrams illustrating the formats of packets for transmitting moving picture mail in accordance with an embodiment of the present invention;

FIG. 6 is a flow chart illustrating a procedure for enabling the one mobile terminal to transmit moving picture mail to the moving picture mail server in accordance with an embodiment of the present invention;

FIG. 7 is a flow chart illustrating a procedure for enabling the moving picture mail server to receive moving picture mail from the one mobile terminal in accordance with an embodiment of the present invention;

FIGS. 8A and 8B are flow charts illustrating a procedure for enabling the moving picture mail server to transmit moving picture mail to the other mobile terminal in accordance with an embodiment of the present invention;

FIG. 9 is a flow chart illustrating a procedure for enabling the other mobile terminal to receive moving picture mail from the moving picture mail server in accordance with an embodiment of the present invention;

FIG. 10 is a block diagram illustrating the format of a reception state message associated with the moving picture mail described in FIG. 9;

FIG. 11 is a block diagram illustrating an operation for enabling the moving picture mail server to transmit moving picture mail from one mobile terminal equipped with the first image codec to the other mobile terminal equipped with the first image codec in accordance with an embodiment of the present invention;

FIG. 12 is a block diagram illustrating an operation for enabling the moving picture mail server to transmit moving picture mail from one mobile terminal equipped with the first image codec to the other mobile terminal equipped with the second image codec in accordance with an embodiment of the present invention; and

FIG. 13 is a block diagram illustrating an operation for enabling the moving picture mail server to transmit moving picture mail from one mobile terminal equipped with the first image codec to the other mobile terminal equipped with software supporting a function of the first image codec in accordance with another embodiment of the present invention.

### DETAILED DESCRIPTION OF THE PREFERRED EMBODIMENTS

Embodiments of the present invention will be described in detail with reference to the accompanying drawings. In the drawings, the same or similar elements are denoted by the same reference numerals.

In the following description, specified details relating to the format of a moving picture signal, the format of a packet to be transmitted, an image compression technique, the transmission rate of moving picture mail, etc. are described as examples. It should be obvious to those skilled in the art that the present invention can be implemented using various modifications without departing from the scope of the present invention.

In an embodiment of the present invention, it is assumed that a moving picture signal includes a moving picture and a semi-moving picture signal. Furthermore, the moving picture signal can be a combined signal in which image signals are combined with other signals in accordance with the embodiment of the present invention. In accordance with the embodiment of the present invention, the moving picture signal can be a combined signal in which image signals are combined with audio signals, a text signal or audio and text signals. Hereinafter, it is assumed that the expression “moving picture signal” or “moving picture mail” refers to a combined signal in which image signals are combined with audio signals. It is assumed that the moving picture signal is the semi-moving picture signal.

In the embodiment of the present invention, it is assumed that a coding technique for transmitting an image signal from a mobile terminal to a moving picture mail server is a Joint Photographic Expert Group (JPEG) coding technique. Alternatively, another image coding technique can be employed in the embodiment of the present invention. In accordance with the embodiment of the present invention, received moving picture signals are coded at predetermined time intervals by means of the JPEG coding technique as the still-picture signal coding technique so that coded image data can be generated.

It is assumed that a portable or mobile terminal for processing moving picture signals is a mobile phone in accordance with the embodiment of the present invention. The portable or mobile terminal in accordance with the embodiment of the present invention can include all mobile communication devices other than the mobile phone.

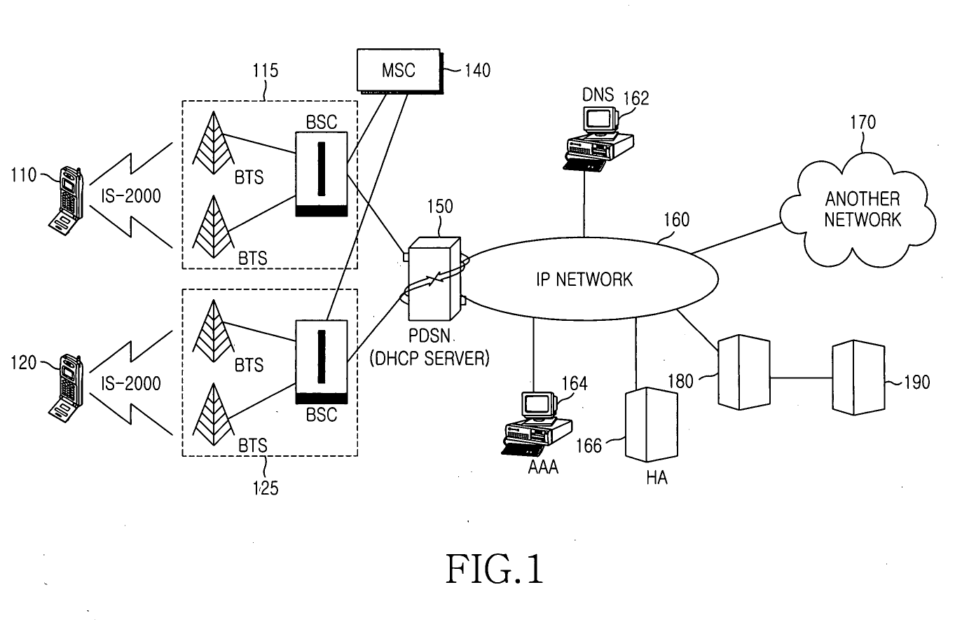

FIG. 1 is a block diagram illustrating the architecture of a network including a mobile communication system capable of transmitting moving picture mail in accordance with an embodiment of the present invention. The mobile communication system network can be based upon a code division multiple access (CDMA) 2000 system.

Referring to FIG. 1, portable or mobile terminals 110 and 120 are connected to base stations (BSs) 115 and 125 and radio channels based upon a CDMA 2000 standard so that a call service can be provided. Conventionally, each of the BSs 115 and 125 includes a base transceiver subsystem (BTS) and a base station controller (BSC). A mobile switching center (MSC) 140 connects the BSs 115 and 125 to another subscriber system of a public switched telephone network (PSTN) or etc. through a path (not shown) so that the call service based on a telephone circuit can be provided to the mobile terminal 120. The BSs 115 and 125 and the MSC 140 form a radio communication network based upon the CDMA 2000 standard.

The BSs 115 and 125 are connected to a data core network, i.e., an Internet protocol (IP) network 160, through a packet data service node (PDSN) 150. Here, the PDSN 150 serves as a gateway for interconnecting the IP network 160 and another network. In particular, the PDSN 150 connected to a wireless communication network can include the MSC 140 according to the advanced network architecture.

The PDSN 150 provides a packet service to the mobile terminals 110 and 120 through a CDMA-based wireless communication network. When the mobile terminal 110 or 120 performs a relay function between the PDSN 140 and a user terminal (not shown), the PDSN 150 establishes a point-to-point protocol (PPP) link with the user terminal, and then assigns an IP address to the user terminal so that the user terminal can access the Internet.

Furthermore, the IP network 160 is connected to another network 170 including a plurality of Internet service providers and nodes, and then provides a packet data service to the mobile terminals 115 and 125. For this, the IP network 160 can be connected to a plurality of network elements, i.e., a domain name server (DNS) 162, an authentication, authorization and accounting (AAA) server 164, a home agent (HA) 166, a moving picture mail server 180, a transcoding server 190, etc.

When moving picture mail arrives, the moving picture mail server 180 confirms a format of the received moving picture mail. Then, the moving picture mail server 180 confirms an image codec of a mobile terminal that will receive the moving picture mail. If the mobile terminal to receive the moving picture mail uses an image coding method compatible with the moving picture mail, the moving picture mail server 180 transmits a moving picture signal to the mobile terminal without transcoding. On the other hand, if the mobile terminal to receive the moving picture mail uses an image coding method incompatible with a moving picture signal, the moving picture mail server 180 performs a transcoding operation for a corresponding moving picture signal and transmits a result of the transcoding operation to the mobile terminal. Furthermore, when the moving picture mail is transmitted, the moving picture mail server 180 transmits the moving picture mail to the mobile terminal in a streaming manner.

The transcoding server 190 can include image and audio codecs for transcoding a moving picture signal. In the embodiment of the present invention, it is assumed that all mobile terminals use the same audio codec. In the embodiment of the present invention, it is assumed that the transcoding server 190 includes at least two image codecs for transcoding a moving picture signal. The transcoding server 190 performs a transcoding operation for moving picture mail transmitted from the moving picture mail server 180 in response to coding information from the moving picture mail server 180.

In the embodiment of the present invention, it is assumed that the mobile terminal 110 transmits moving picture mail to the moving picture mail server 180 and the mobile terminal 120 receives the moving picture mail transmitted from the moving picture mail server 180. Furthermore, it is assumed that the moving picture mail transmitted from the mobile terminal 110 is a JPEG coded moving picture signal and the mobile terminal 120 uses a JPEG or wavelet coding method.

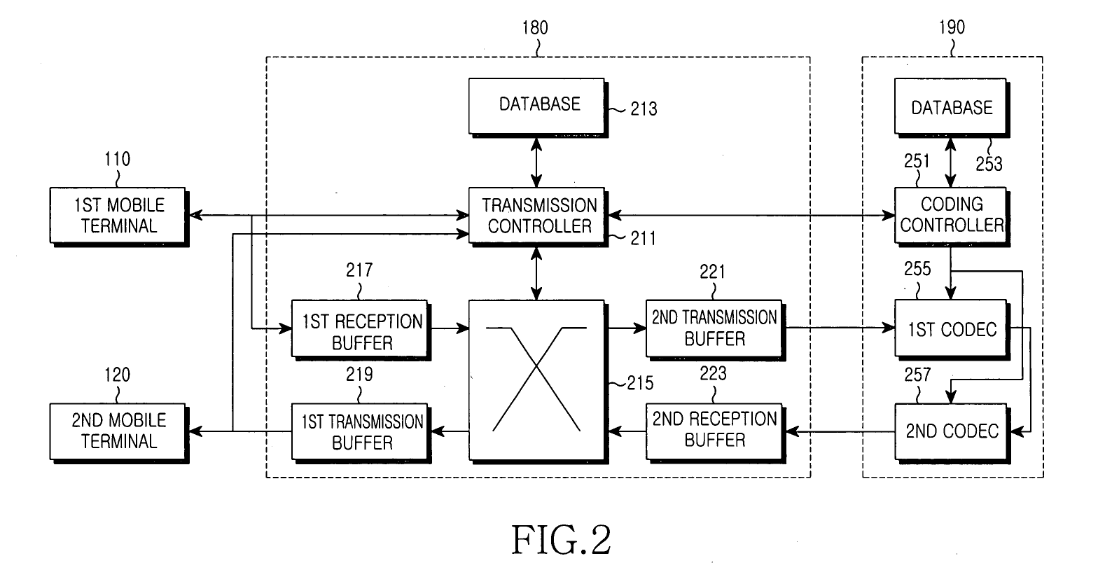

FIG. 2 is a block diagram illustrating components for communicating moving picture mail between the mobile terminals 110 and 120, the moving picture mail server 180 and the transcoding server 190 in accordance with an embodiment of the present invention.

Referring to FIG. 2, the moving picture mail server 180 performs a function of controlling a transmission operation for the moving picture mail. A configuration of the moving picture mail server 180 will be described below. A transmission controller 211 confirms a coding technique for moving picture mail transmitted from the first mobile terminal 110, and confirms an image codec provided in the second mobile terminal 120 that will receive the moving picture mail. Furthermore, the transmission controller 211 drives the transcoding server 190 if the first and second mobile terminals 110 and 120 use different coding techniques. Coding information of the first and second mobile terminals 110 and 120 is transmitted. The transmission controller 211 generates a switch control signal for controlling a transmission/reception path of the moving picture mail. That is, the transmission controller 211 generates the first switch control signal if the first and second mobile terminals 110 and 120 use the same coding technique, and generates the second switch control signal if the first and second mobile terminals 110 and 120 use different coding techniques.

The transmission controller 211 stores, in a database 213, codec information of the first and second mobile terminals 110 and 120 communicating the moving picture mail. The transmission controller 211 accesses the codec information stored in the database 213.

The first reception buffer 217 buffers moving picture mail received from the first mobile terminal 110, and the first transmission buffer 219 buffers moving picture mail to be transmitted to the second mobile terminal 120. Furthermore, the second transmission buffer 221 buffers moving picture mail to be transmitted to the transcoding server 190 and the second reception buffer 223 buffers moving picture mail received from the transcoding server 190. When the first switch control signal is generated from the transmission controller 211, that is, the first and second mobile terminals 110 and 120 use the same coding technique, a path switch 215 switches an output of the first reception buffer 217 to the first transmission buffer 219. Furthermore, when the second switch control signal is generated from the transmission controller 211, that is, the first and second mobile terminals 110 and 120 use different coding techniques, the path switch 215 switches an output of the first reception buffer 217 to the second transmission buffer 221, and switches an output of the second reception buffer 223 to the first transmission buffer 219.

The transcoding server 190 performs a transcoding operation for the moving picture mail between the mobile terminals 110 and 120 using the different coding techniques under the control of the moving picture mail server 180. If the mobile terminals 110 and 120 use different coding techniques, the transmission controller 211 of the moving picture mail server 180 transmits a transcoding drive request and coding information of the mobile terminals 110 and 120 to a coding controller 251 of the transcoding server 190. Under the control of the transmission controller 211, the coding controller 251 confirms coding information of the moving picture mail transmitted from the first mobile terminal 110 and coding information of the second mobile terminal 120, and generates the first codec selection signal and the second codec selection signal. A database 253 stores information of codecs provided in the transcoding server 190. The first codec 255 is selected in response to the first codec selection signal, and decodes moving picture mail output from the second transmission buffer 221. The second codec 257 is selected in response to the second codec selection signal, and codes moving picture mail output from the first codec 255 to output a result of the coding to the second reception buffer 223.

In the embodiment of the present invention, it is assumed that the moving picture mail server 180 and the transcoding server 190 operate independently. However, the first codec 255 and the second codec 257 of the transcoding server 190 can be integrated within the moving picture mail server 180.

Referring to FIG. 2, an operation for enabling the transmission controller 211 of the moving picture mail server 180 to confirm an image codec of the first mobile terminal 110 and an image codec of the second mobile terminal 120 can be implemented on the basis of two methods. The first method is to allow users of the mobile terminals 110 and 120 to register codec information necessary for communicating the moving picture mail. In this case, the codec information transmitted from the mobile terminals 110 and 120 is stored in the database 213 by the transmission controller 211. When the moving picture mail is communicated, the moving picture mail coding techniques of the first and second mobile terminals 110 and 120 are confirmed from the database 213 and hence a transmission operation is controlled. The second method is to confirm the coding techniques by inquiring of the first and second mobile terminals 110 and 120 about the coding techniques of communication-capable moving picture mail and then control a transmission operation. In this case, the transmission controller 211 inquires of the first and second mobile terminals 110 and 120 about the coding techniques of moving picture mail when the moving picture mail is communicated.

In FIG. 2, it is assumed that the coding techniques of the mobile terminals 110 and 120 are registered in the database 213.

When the moving picture mail is generated from the first mobile terminal 110, the second mobile terminal 120 is designated as a destination terminal and the generated moving picture mail is transmitted to the moving picture mail server 180. The transmission controller 211 confirms moving picture coding techniques of the first and second mobile terminals 110 and 120 from the database 213, and the switch 215 switches a switch control signal according to a result of the confirmation. At this point, the transmission controller 211 generates the first switch control signal when the two mobile terminals 110 and 120 use the same coding technique. Furthermore, the transmission controller 211 generates the second switch control signal when the two mobile terminals 110 and 120 use the different coding techniques.

When the transmission controller 211 generates the first switch control signal, the switch 215 switches an output path of the first reception buffer 217 to an input path of the first transmission buffer 219. Thus, the moving picture mail buffered in the first reception buffer 217 is output to the first transmission buffer 219 via the switch 215. The first transmission buffer 219 transmits the buffered moving picture mail to the second mobile terminal 120. Therefore, where the first and second mobile terminals 110 and 120 use the same coding technique, the moving picture mail server 180 performs a control operation so that the moving picture mail can be output without transcoding.

When the transmission controller 211 generates the second switch control signal, the switch 215 switches an output path of the first reception buffer 217 to an input path of the second transmission buffer 221, and switches an output path of the second reception buffer 223 to an input path of the first transmission buffer 219. Furthermore, the transmission controller 211 transmits coding information of the first mobile terminal 110 and coding information of the second mobile terminal 120 to the coding controller 251 of the transcoding server 190. Then, the coding controller 251 selects the first codec 255 and the second codec 257 according to the coding information. At this point, the first codec 255 and the second codec 257 use different coding techniques. The moving picture mail buffered in the first reception buffer 217 is output to the second transmission buffer 221 via the switch 215. The first codec 255 is the same as the codec provided in the first mobile terminal 110 and decodes the moving picture mail from the second transmission buffer 221 into an original moving picture signal. The second codec 257 is the same as a codec provided in the second mobile terminal 120, and codes the decoded moving picture mail from the first codec 255 to output the coded moving picture mail to the second reception buffer 223. Consequently, it can be found that a transcoding operation for the moving picture mail coded by the coding technique of the first mobile terminal 110 is performed on the basis of the coding technique of the second mobile terminal 120 via the first codec 255 and the second codec 257 and a result of the transcoding operation is output. Then, the transcoded moving picture mail output from the second reception buffer 223 is transferred to the first transmission buffer 219 via the switch 215, and the first transmission buffer 219 transmits the buffered moving picture mail to the second mobile terminal 120.

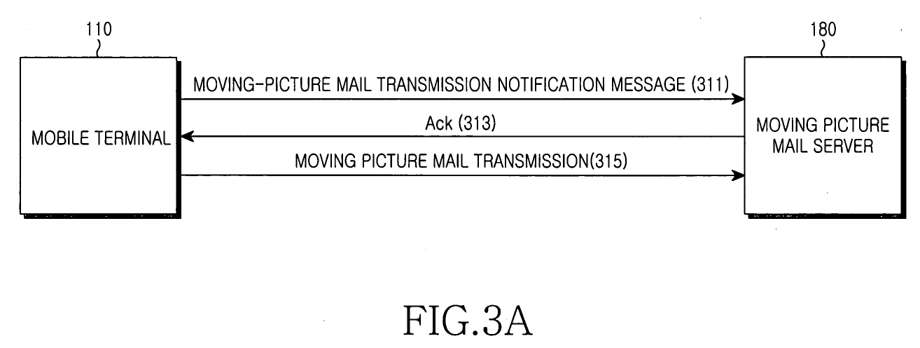

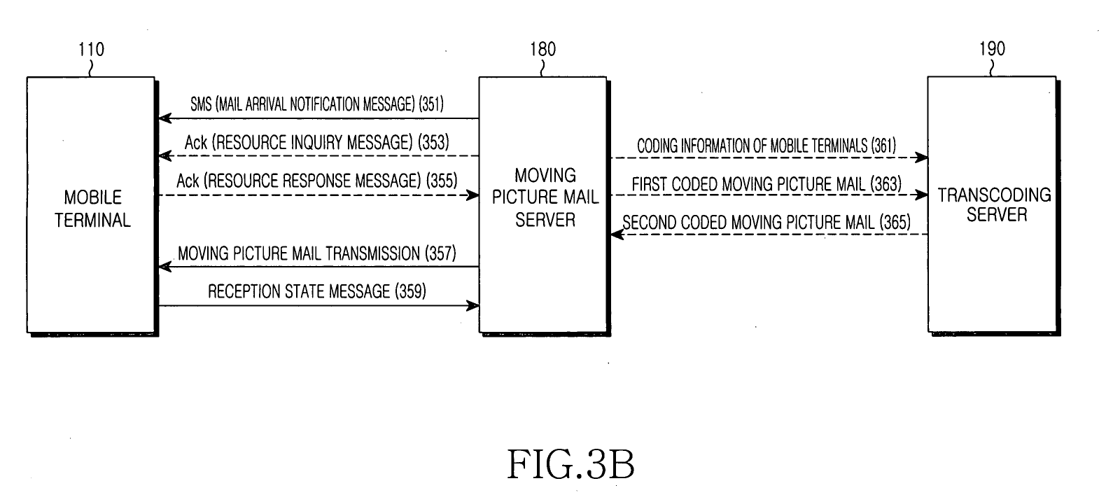

FIG. 3A is a block diagram illustrating a procedure for enabling the mobile terminal 110 shown in FIG. 1 to transmit moving picture mail to the moving picture mail server 180 shown in FIG. 1 in accordance with an embodiment of the present invention. In FIG. 3A, it is assumed that coding information of the mobile terminals is not stored in the database 213 of the moving picture mail server 180.

Referring to FIG. 3A, upon generating moving picture mail destined for the second mobile terminal 120, the first mobile terminal 110 transmits, to the moving picture mail server 180, a transmission notification message indicating that the moving picture mail destined for the second mobile terminal 120 will be transmitted at step 311. The transmission notification message can contain information on the second mobile terminal 120 being the destination terminal, coding information of the moving picture mail from the first mobile terminal 110, and moving picture mail format information. In response to the moving-picture mail transmission notification message, the moving picture mail server 180 confirms the coding information of the first mobile terminal 110 and then transmits a response message at step 313. In response to the response message, the first mobile terminal 110 transmits the moving picture mail at step 315.

FIG. 3B is an explanatory diagram illustrating a procedure for enabling the moving picture mail server shown in FIG. 1 to transmit received moving picture mail to the mobile terminal 120 shown in FIG. 1 in accordance with an embodiment of the present invention. In the explanation of FIG. 3B, it is assumed that coding information of the mobile terminals is not stored in the database 213 of the moving picture mail server 180.

Referring to FIG. 3B, upon recognizing the moving picture mail destined for the second mobile terminal 120, the moving picture mail server 180 generates a moving-picture mail arrival notification message and then transmits the generated moving-picture mail arrival notification message to the second mobile terminal 120 at step 351. When the second mobile terminal 120 responds to the moving-picture mail arrival notification message, the moving picture mail server 180 transmits a resource inquiry message for inquiring about the resources of the second mobile terminal 120 at step 353. The resource inquiry message contains a request for coding information of the second mobile terminal 120. Then, the second mobile terminal 120 generates and transmits a response message containing its own coding information as a response to the resource inquiry message at step 355.

The moving picture mail server 180 receiving the response message analyzes a coding method for the moving picture mail and the coding information of the second mobile terminal 120. If the first and second mobile terminals 110 and 120 use the same coding technique, the moving picture mail server 180 begins to transmit the moving picture mail destined for the second mobile terminal 120 at a preset transmission rate at step 357. On the other hand, if the first and second mobile terminals 110 and 120 use different coding techniques, the moving picture mail server 180 transmits the coding information of the first and second mobile terminals 110 and 120 and the received moving picture mail as the first coded moving picture mail to the transcoding server 190 at steps 361 and 363. If so, the transcoding server 190 decodes the first coded moving picture mail into an original moving picture mail and codes the decoded moving picture mail by means of the second coding technique of the second mobile terminal 120 to transmit the second coded moving picture mail to the moving picture mail server 180 at step 365. Then, the moving picture mail server 180 begins to transmit the moving picture mail destined for the second mobile terminal at a preset transmission rate.

The second mobile terminal 120 must include a minimum buffer space required for receiving the moving picture mail and enabling the received moving picture mail to be displayed in real time. For example, when the moving picture mail server 180 transmits image and audio signals corresponding to 5 frames per second according to a standard of moving picture mail, the second mobile terminal 120 must include a buffer capable of buffering moving picture mail data of 5 seconds or more. Furthermore, when the buffer is full, the second mobile terminal 120 performs an operation for accessing and reproducing moving pictures stored in the buffer and an operation for receiving and storing moving picture mail transmitted from the moving picture mail server 180, simultaneously.

In a state in which the operation for reproducing and receiving the moving picture mail is performed, the second mobile terminal 120 checks for buffering depth indicating an amount of data accumulated in the buffer at a predetermined time interval, determines the state of a communication network according to a result of the check, and notifies the moving picture mail server 180 of the result of the determination. That is, the second mobile terminal 120 generates a reception state message indicating the communication network state at a predetermined time interval and then transmits the generated reception state message to the moving picture mail server 180 at step 359. Furthermore, the moving picture mail server 180 varies a transmission rate of moving picture mail according to a current environment of the communication network in response to the reception state message and performs a transmission operation at the varied transmission rate at step 357.

In accordance with the embodiment of the present invention, the first mobile terminal 110 of the transmitting side and the moving picture mail server 180 transmit the moving picture mail to the moving picture mail server 180 and the second mobile terminal 120 of the receiving side in the streaming manner, respectively. The transmission rate of moving picture mail can be variably adjusted according to the reception state information transmitted from the moving picture mail server 180 and the second mobile terminal 120 of the receiving side at a predetermined time interval. This operation is performed in order to compensate for a cut-off phenomenon of a moving picture signal to be reproduced by the moving picture mail server 180 and the second mobile terminal 120 of the receiving side.

In the embodiment of the present invention, the method for enabling the transmitting side to vary the transmission rate of moving picture mail as described above can be implemented in a variety of forms. First, although the transmission rate is changed according to a channel environment because the moving picture mail transmitted from the first mobile terminal 110 to the moving picture mail server 180 is moving picture mail destined for the second mobile terminal 120, a total of the moving picture mail from the first mobile terminal 110 is completely transmitted to the second mobile terminal 120 via the moving picture mail server 180. Second, where the transmission rate is varied according to the channel environment because the moving picture mail transmitted to the second mobile terminal 120 via the moving picture mail server 180 is displayed in real time, the moving picture mail is reduced and the reduced moving picture mail is transmitted to the second mobile terminal 120. When the transmission rate is adjusted in the first method, a size of data received by the moving picture mail server 180 is the same as that of data received by the second mobile terminal 120 but a time period taken to transmit the moving picture mail is varied. On the other hand, when the transmission rate is adjusted in the second method, a transmission time is not varied but the size of data to be transmitted is varied.

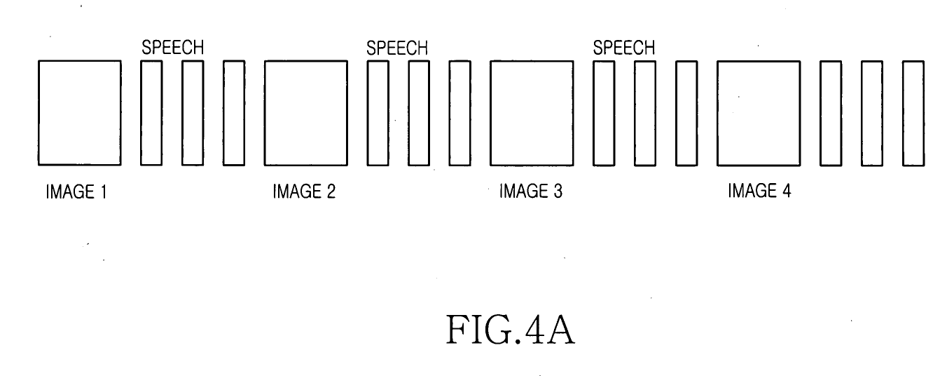

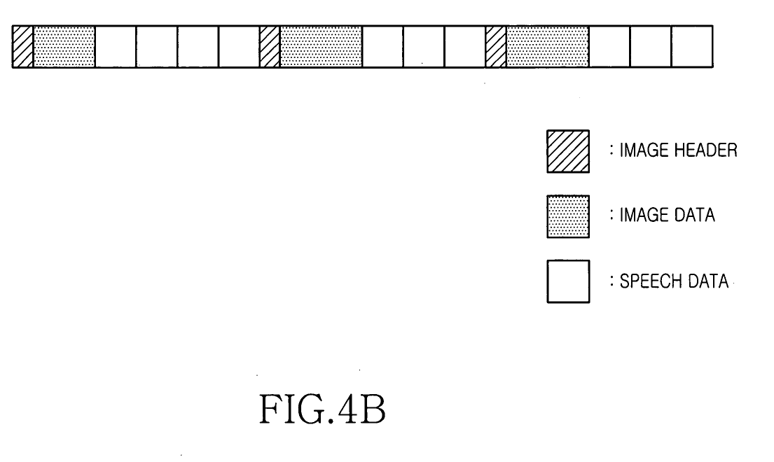

In accordance with the embodiment of the present invention, it is assumed that the moving picture mail includes consecutive still picture signals JPEG1, JPEG2 and others and audio signals, and the audio signals are interlaced between the still picture signals JPEG 1, JPEG2 and others as shown in FIG. 4A. That is, it is assumed that the moving picture mail as the semi-moving picture signal has a format in which the audio signals are inserted between the still picture signals. The still picture signal is an image screen signal of one frame. An image header containing “L” indicating a size of a corresponding frame and a pattern signal “P” indicating the existence of an image is inserted into the still picture signal. In this case, the moving picture mail can have a format in which the image headers, the JPEG coded image signals and the audio signals are combined as shown in FIG. 4B.

When the moving picture mail is transmitted, the first mobile terminal 110 and the moving picture mail server 180 generates transmission packets of the moving picture mail and transmits the generated packets.

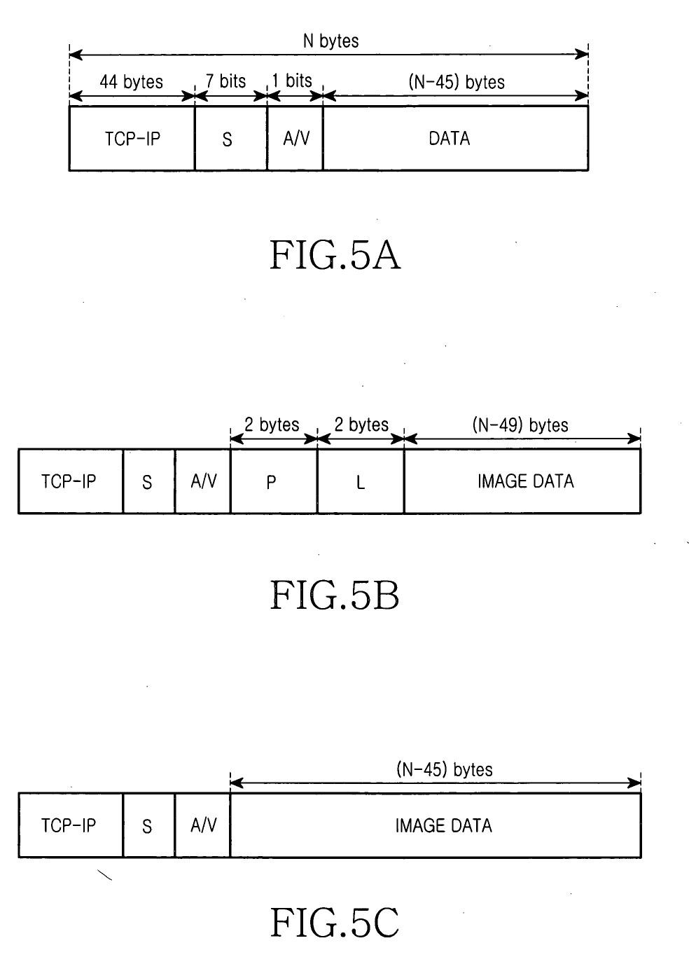

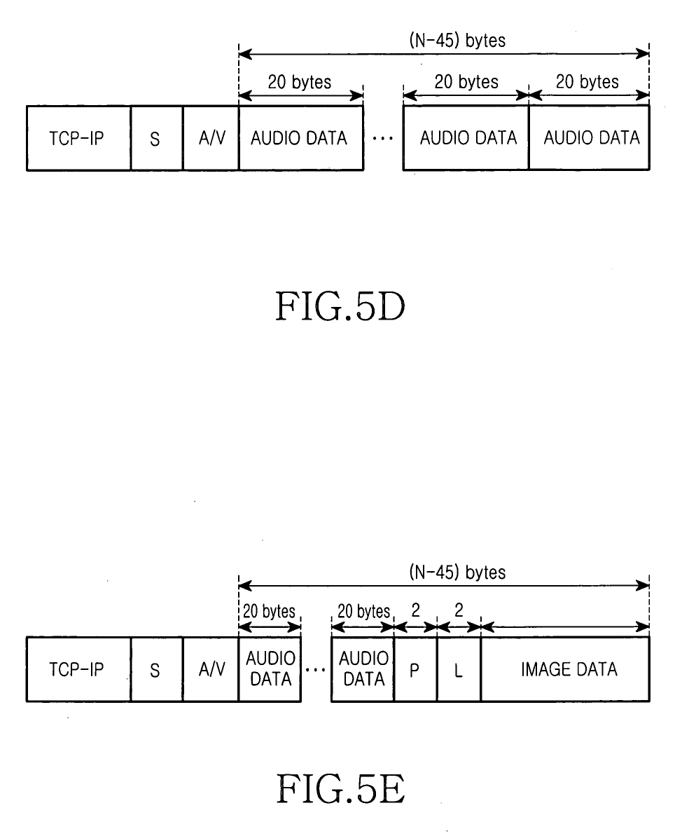

FIGS. 5A though 5E are block diagrams illustrating the formats of packets for transmitting the moving picture mail in accordance with an embodiment of the present invention.

FIG. 5A shows the format of a packet to be transmitted from the moving picture mail server 180. A total size N of the packet to be transmitted can be selectively determined, and the total size N can be set within the range of approximately 200 to 1500 bytes. The size of a packet to be transmitted must be constant in every packet. Referring to the packet format, a Transmission Control Protocol/Internet Protocol (TCP/IP) header of 44 bytes and a sequence number S of 7 bits can be contained within the packet. The sequence number S indicates a sequence of generated packets. The sequence number may have one of a value 0 to a value 127. After the sequence number of the value 127, the sequence number of the value 0 is newly selected. A 1-bit AN value subsequent to the sequence number S indicates whether the first data of a corresponding packet is audio or JPEG image data.

FIGS. 5B and 5C show packets of JPEG image data formats. In the case of the JPEG image data, the size of one frame is set within the range of 5 to 10 Kbytes. The image data length of one frame is longer than that of data of one packet. Thus, the JPEG image data of one frame must be transmitted through a plurality of packets. The first packet of the frame image data includes P and L values of the image header as shown in FIG. 5B. In FIG. 5B, the P value indicates a pattern signal used for discriminating audio data and JPEG image data in a receiver receiving packet data, and is image header information. In FIG. 5B, the L value indicates the total size of a JPEG image frame. The mobile terminal detects a JPEG image through the pattern signal P from the transmitted packet shown in FIG. 5B, and reads JPEG image data corresponding to the L value. When the received and buffered data corresponds to the L value while the mobile terminal consecutively receives and buffers data, the received and buffered JPEG image data is applied to an image codec of the mobile terminal so that it can be decoded and reproduced. FIG. 5C shows the remaining packet format after the first packet of JPEG image data of one frame is transmitted. The remaining packet can be filled with JPEG image data without an image header.

FIG. 5D shows the format of an audio signal packet. In the embodiment of the present invention, it is assumed that an audio codec of the mobile terminal is an 8 Kbps speech codec. When the audio codec is the 8 Kbps speech codec, coded audio data of one frame (20 bytes) is generated every 20 msec. Until N—45 bytes corresponding to the maximum size of data are assembled in one packet, a plurality of coded audio frame data units are consecutively coupled to one another so that an audio packet can be generated. For example, when N is 200, a plurality of audio data units corresponding to 17 frames and a ¾ frame (15 bytes) are assembled, such that one packet can be generated. Since the JPEG image data is typically inserted between the audio frames, a format in which audio data and JPEG image data are mixed is generated as shown in FIG. 5E.

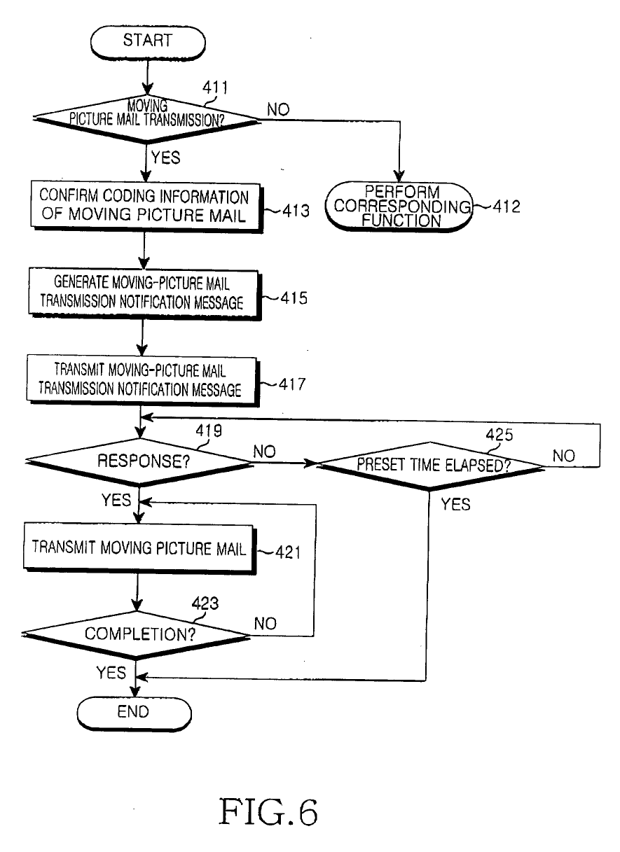

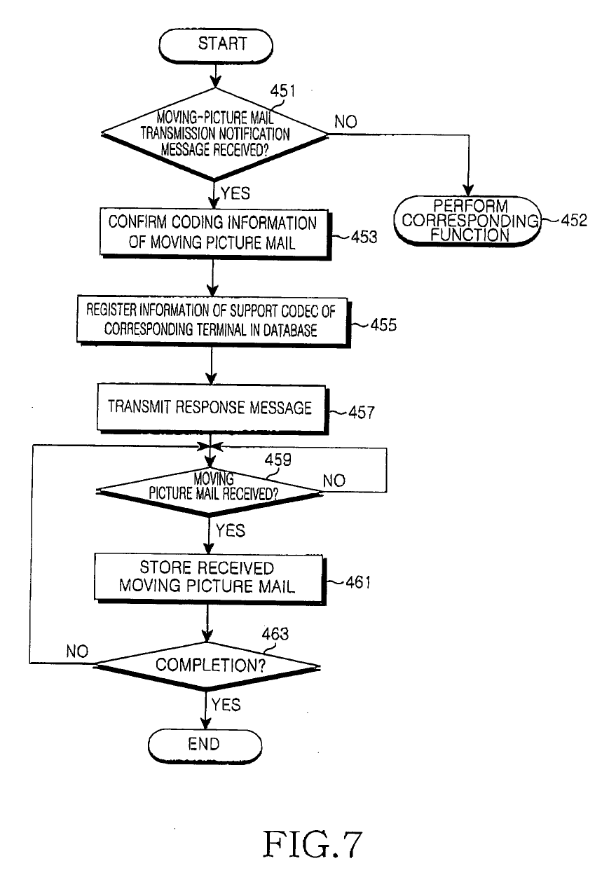

FIG. 6 is a flow chart illustrating a procedure for enabling the mobile terminal 110 to transmit moving picture mail to the moving picture mail server 180 in accordance with an embodiment of the present invention; and FIG. 7 is a flow chart illustrating a procedure for enabling the moving picture mail server 180 to receive moving picture mail from the mobile terminal 110 in accordance with an embodiment of the present invention.

An operation for enabling the moving picture mail server 180 to transmit the moving picture mail and an operation for enabling the mobile terminal 120 to receive the moving picture mail will be described with reference to FIGS. 6 and 7.

The user makes a moving picture mail transmission request, if the mobile terminal does not recognize the moving picture transmission request at step 411, the method proceeds to step 412 where other functions are performed. If the mobile terminal 110 recognizes the moving picture transmission request at step 411. Then, the mobile terminal 110 confirms coding information of the moving picture mail to be transmitted at step 413. Then, the mobile terminal 110 generates a moving-picture mail transmission notification message containing the coding information of the moving picture mail and information of the second mobile terminal 120 being the destination of the moving picture mail at step 415 and then transmits the generated message at step 417. After transmitting the moving-picture mail transmission notification message, the first mobile terminal 110 waits to receive a response message from the moving picture mail server 180. Upon receiving the response message from the moving picture mail server 180, the first mobile terminal 110 sequentially transmits data of the moving picture mail at step 421. When it is determined that the moving picture mail has been completely transmitted at step 423, the moving picture mail transmission is terminated. If no response message has been received during a preset time at step 419, the first mobile terminal 110 recognizes the fact that no response message has been received during the preset time at step 425, the moving picture mail transmission is then terminated.

Referring now to FIG. 7 a determination is made as to whether the moving-picture mail transmission notification message has been received from the first mobile terminal 110. If the query at step 451 is answered negatively, the method proceeds to step 452 where other corresponding functions are performed. If the query at step 451 is answered affirmatively, the moving picture mail server 180 recognizes the fact that the moving picture mail transmission notification message has been received. The moving picture mail server 180 checks the coding information contained in the received message and confirms a support codec of the first mobile terminal 110 at step 453, and registers information of the support codec in the database 213 at step 455. Then, the moving picture mail server 180 transmits the response message to the first mobile terminal 110 and waits to receive the moving picture mail at step 457. Upon receiving the moving picture mail, the moving picture mail server 180 recognizes that the moving picture mail has been received at step 459, and stores the received moving picture mail at step 461. The above-described operations are repeatedly performed until the moving picture mail is completely transmitted.

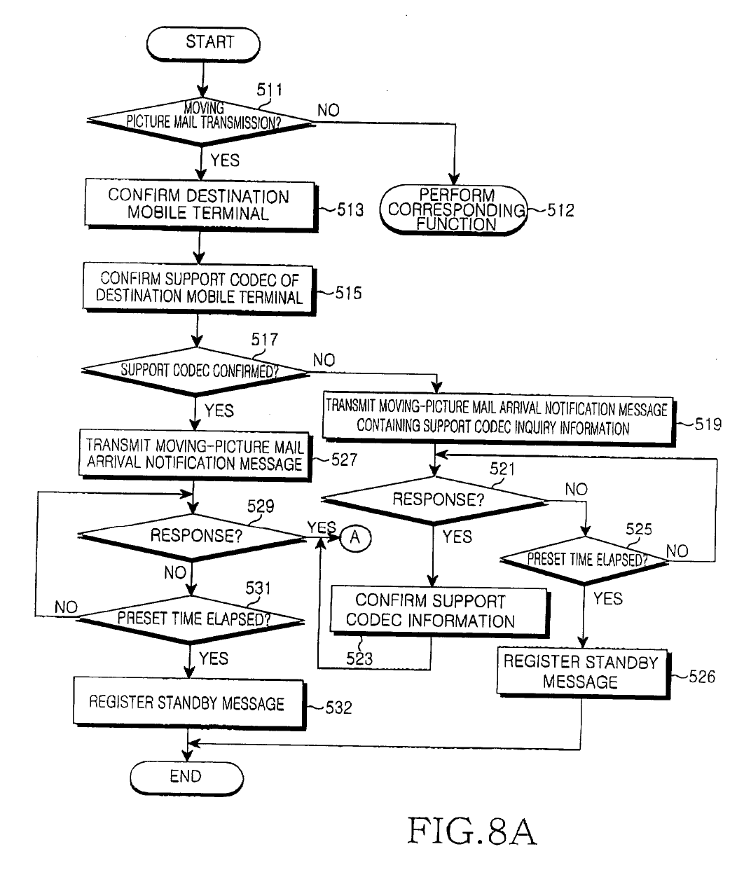

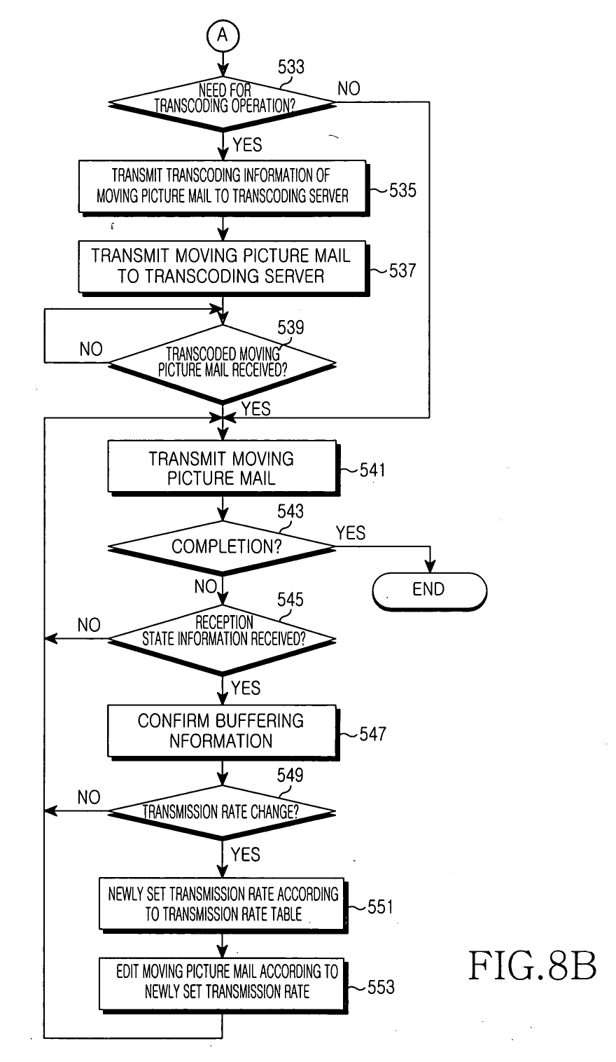

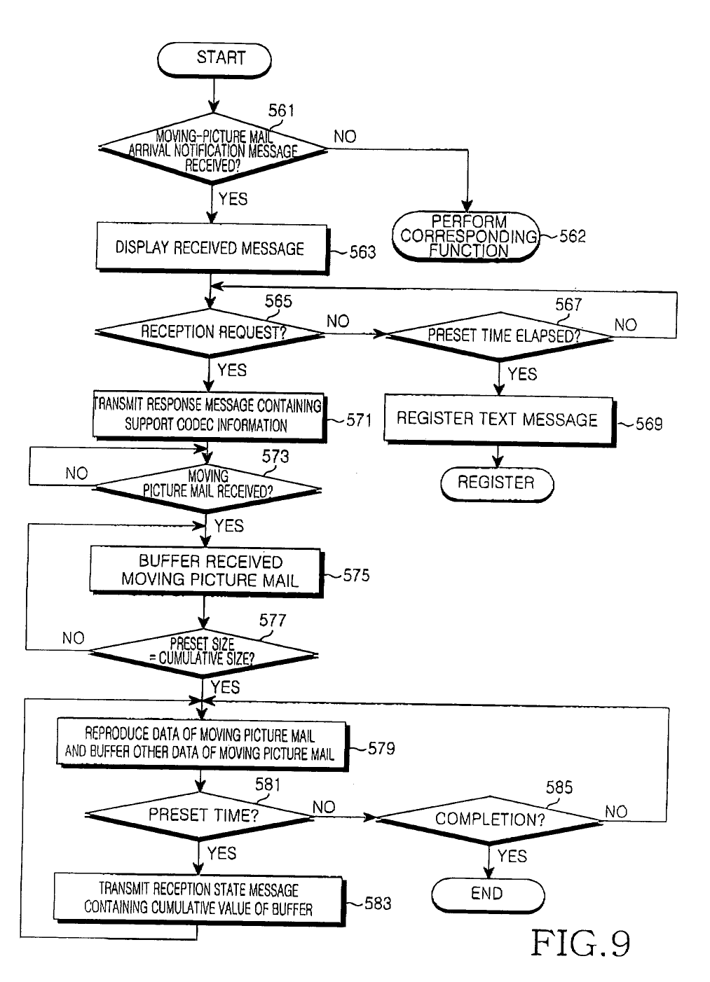

As shown in FIGS. 6 and 7, the moving picture mail transmitted from the first moving picture mail 110 is transmitted to the moving picture mail server 180 and the transmitted moving picture mail is stored in the moving picture mail server 180. The stored moving picture mail is transmitted to the second mobile terminal 120 being the destination terminal while the procedures shown in FIGS. 8A, 8B and 9 are performed. At this point, where the moving picture mail server 180 cannot immediately transmit the received moving picture mail, the received moving picture mail is stored in a moving picture mail buffer area assigned to the database 213.

FIGS. 8A and 8B are flow charts illustrating a procedure for enabling the moving picture mail server 180 to transmit moving picture mail to the second mobile terminal 120 after performing the transcoding operation for the moving picture mail in accordance with an embodiment of the present invention. FIG. 9 is a flow chart illustrating a procedure for enabling the second mobile terminal 120 to receive moving picture mail from the moving picture mail server 180 in accordance with an embodiment of the present invention. The second mobile terminal 120 feeds back the information necessary for changing the transmission rate according to a transmission state of the moving picture mail to the moving picture mail server 180. The moving picture mail server 180 varies the transmission rate of the moving picture mail according to the feedback information.

Referring to FIGS. 8A, 8B and 9, A determination is made as to whether a moving picture mail notification message has been received at step 511. If the query at step 511 is answered negatively, the method proceeds to step 512 where a corresponding function is performed. If the query at step 511 is answered affirmatively, the moving picture mail server 180 recognizes the fact that the moving picture mail arrival notification message has been received. The moving picture mail server 180 determines, from the moving picture mail arrival notification message, that the second mobile terminal 120 is the destination terminal at step 513. The moving picture mail server 180 determines whether support codec information of the second mobile terminal 120 is contained in the database 213. At this point, if the support codec information of the second mobile terminal 120 is not contained in the database 213, the moving picture mail server 180 recognizes the fact that the support codec information of the second mobile terminal 120 is not contained in the database 213 at step 517, and hence steps 519 to 525 are performed. On the other hand, if the support codec information of the second mobile terminal 120 is contained in the database 213, the moving picture mail server 180 recognizes the fact that the support codec information of the second mobile terminal 120 is contained in the database 213 at the above step 517, and hence steps 527 to 531 are performed.

Support codec information of the terminals stored in the database 213 can be support codec information confirmed in the process of communicating the moving picture mail as shown in FIGS. 6 and 7, and can be support codec information confirmed in the process of transmitting the moving picture mail as shown in FIGS. 8A and 8B. As described above, the support codec information of the terminals stored in the database 213 can be support codec information registered by the terminals before each terminal transmits the moving picture mail. In the embodiment of the present invention, it is assumed that the support codec information of the terminals can be information confirmed in the process of communicating the moving picture mail and the confirmed information is stored in the database 213. It is assumed that support codec information of a terminal not registered in the database 213 is confirmed in the process of transmitting the moving picture mail, and the confirmed support codec information of the terminal is stored and maintained in the database 213.

If it is determined that the support codec information of the second mobile terminal 120 to receive the moving picture mail has not been registered in the database 213 at the above step 517, the moving picture mail server 180 generates and transmits a moving-picture mail arrival notification message containing information for inquiring of the second mobile terminal 120 about its support codec information at step 519. If the second mobile terminal 120 transmits a response message within a preset time, the moving picture mail server 180 recognizes the response message, confirms support codec information of the second mobile terminal 120 contained in the response message, and registers the confirmed support codec information in the database 213 at step 523. However, if no response message has been received within the preset time, the moving picture mail server 180 recognizes the fact that no response message has been received within the preset time at step 525, registers a standby message indicating that moving picture mail to be transmitted to the second mobile terminal 120 is present at step 526, and terminates the procedure for transmitting the moving picture mail.

If it is determined, at the above step 517, that the support codec information of the second mobile terminal 120 to receive the moving picture mail has been registered in the database 213, the moving picture mail server 180 confirms the support codec information of the second mobile terminal 120, generates a moving-picture mail arrival notification message and transmits the generated moving-picture mail arrival notification message to the second mobile terminal 120 at step 527. When the second mobile terminal 120 transmits a response message within the preset time, the moving picture mail server 180 recognizes the response message at step 529. However, when no response message has been received within the preset time, the moving picture mail server 180 recognizes the fact that no response message has been received within the preset time at step 531, registers a standby message indicating that moving picture mail to be transmitted to the second mobile terminal 120 is present at step 532, and terminates the procedure for transmitting the moving picture mail.

After confirming the support codec information of the second mobile terminal 120 to receive the moving picture mail, the moving picture mail server 180 confirms support codec information of the first mobile terminal 110. The moving picture mail server 180 determines whether a transcoding operation must be performed. That is, the moving picture mail server 180 determines, at step 533, whether or not support codecs of the first and second mobile terminals 110 and 120 are different. If the support codecs of the first and second mobile terminals 110 and 120 are different, the moving picture mail server 180 recognizes the fact that the support codecs of the first and second mobile terminals 110 and 120 are different at the above step 533. The moving picture mail server 180 transmits the coding information of the moving picture mail and the support codec information of the second mobile terminal 120 to the transcoding server 190 at step 535. Then, the coding controller 251 of the transcoding server 190 selects the first codec 255 as a codec based upon the coding information of the moving picture mail (i.e., the support codec information of the first mobile terminal 110) received from the moving picture mail server 180 and selects the second codec 257 as a codec based upon the support codec information of the second mobile terminal 120. Then, the moving picture mail server 180 transmits the received moving picture mail to the transcoding server 190 at step 537.

The coding controller 251 of the transcoding server 190 controls the first codec 255 so that the received moving picture mail is decoded into an original image signal, and controls the second codec 257 so that the moving picture mail can be coded and the coded moving picture mail can be transmitted to the second mobile terminal 120. The moving picture mail server 180 waits to receive the moving picture mail output from the transcoding server 190 at step 539. Thus, the moving picture mail server 180 enables the transcoding server 190 to perform a transcoding function while the above steps 535 to 539 are performed so that the codec of the second mobile terminal 120 can decode the moving picture mail coded by the codec of the first mobile terminal 110.

The moving picture mail server 180 begins to transmit the moving picture mail or the transcoded moving picture mail to the second mobile terminal 120 at a set transmission rate at step 541. This operation is continuously performed at the set transmission rate before a reception state message is received from the second mobile terminal 120.

At step 561 a determination is made as to whether a moving picture mail arrival notification message has been received. If the query is answered negatively, the method proceeds to step 562 where corresponding functions are performed. If the query is answered affirmatively, the second mobile terminal 120 recognizes the received message and displays the recognized message on a display unit so that the user confirms the displayed message at step 563. If no moving picture mail reception request has been generated within a preset time, the second mobile terminal 120 recognizes the fact that no moving picture mail reception request has been generated while performing steps 565 to 569 and registers the received message as a text or character message based upon a short message service (SMS), and a termination operation is performed. The registered text message can be confirmed in the future in order for the moving picture mail to be received.

However, if the moving picture mail reception request has been generated within the preset time, the second mobile terminal 120 recognizes the generated request at step 565. Then, the second mobile terminal 120 analyzes information contained in the moving picture mail arrival notification message and generates a response message containing support codec information to transmit the generated response message at step 571. At this time, only where transmitting a support codec information request through the moving picture mail arrival notification message, the second mobile terminal 120 transmits its own support codec information. Alternatively, the second mobile terminal 120 can transmit the support codec information irrespective of the support codec information request contained in the moving picture mail arrival notification message. After transmitting the response message, the second mobile terminal 120 waits to receive the moving picture mail at step 573.

Then, when the moving picture mail server 180 transmits the moving picture mail, the second mobile terminal 120 recognizes the moving picture mail at the above step 573 and accumulates and stores the received moving picture mail in a buffer at step 575. Then, when a predetermined size (i.e., 125 Kbytes) of moving picture mail stored in the buffer has been received, the second mobile terminal 120 recognizes the fact that the received moving picture mail stored in the buffer has reached the predetermined size (i.e., 125 Kbytes) at step 577 and accesses the moving picture mail stored in the buffer to display the moving picture mail on a display unit at step 579. The second mobile terminal 120 continuously performs an operation for buffering other data of the moving picture mail transmitted from the moving picture mail server 180.

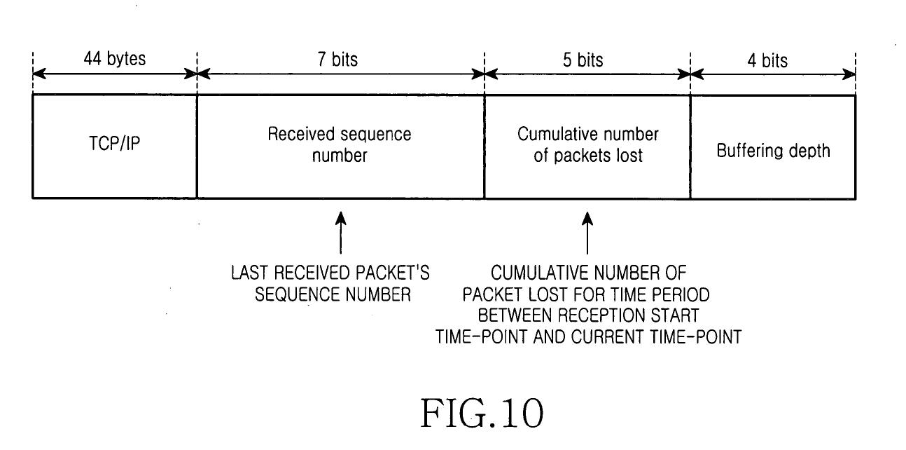

The second mobile terminal 120 checks an amount of data accumulated in the buffer at a preset time interval, and generates a message based upon the state of a communication network. If a preset time has elapsed, the second mobile terminal 120 recognizes the fact that the preset time has elapsed at step 581, and checks an amount of data accumulated in the buffer and generates a reception state message to transmit the generated reception state message to the moving picture mail server 180 at step 583. The reception state message has a format shown in FIG. 10. The format of the reception state message contains a TCP/IP header, a received sequence number, the cumulative number of packets lost, buffering information indicating buffering depth, etc. The buffering information indicates an amount of data accumulated in the buffer and can be determined on the basis of the following Table 1. A range of an “x” value contained in the following Table 1 can be varied according to a request from a communication carrier after characteristics of the communication network are analyzed before the service initiation. The buffering information is used as information for deciding a transmission rate of the moving picture mail in the moving picture mail server 180, and is contained in the reception state message shown in FIG. 10 so that the buffering information contained in the reception state message can be transmitted to the moving picture mail server 180.

TABLE 1

| Amount of data accumulated in buffer | Buffering depth |
|---|---|
| (x: Kbytes) | (Bits) |
| 125 ≦ x | 0110 |
| 100 ≦ x < 125 | 0101 |
| 75 ≦ x < 100 | 0100 |
| 50 ≦ x < 75 | 0011 |
| 25 ≦ x < 50 | 0010 |
| 10 ≦ x < 25 | 0001 |
| x < 10 | 0000 |

When the second mobile terminal 120 transmits the reception state message shown in FIG. 10, the moving picture mail server 180 recognizes the reception state message at step 545 shown in FIG. 8B, analyzes the buffering information contained in the reception state message at step 547 and determines whether a transmission rate must be changed on the basis of a result of the analysis. If the buffering information has not been changed, the moving picture mail server 180 recognizes the fact that the buffering information has not been changed at step 549 and returns to the above step 541 so that the moving picture mail can be transmitted at the previous transmission rate. On the other hand, if the moving picture mail server 180 recognizes the fact that the buffering information has been changed at the above step 549, the moving picture mail server 180 newly sets the transmission rate on the basis of a transmission rate change or assignment table at step 551 and then edits the moving picture mail according to the newly set transmission rate to transmit the edited moving picture mail at step 553.

TABLE 2

| Buffering depth | Transmission rate |
|---|---|
| (Bits) | (Frames per sec) |
| 0110 | Max |
| 0101 | 5 |
| 0100 | 4 |
| 0011 | 3 |
| 0010 | 2 |
| 0001 | 1 |
| 0000 | 0 |

Table 2 shows an example of the transmission rate change or assignment table. The moving picture mail server 180 includes the transmission rate assignment table such as the above Table 2 and can adjust the transmission rate indicating the number of frames per second. In the above Table 2, it is assumed that the number of frames per second is “5”in a normal environment, and its buffering information indicates “0101”. Furthermore, when the buffering information of the reception state message is “0011”, the number of frames per second to be transmitted is set to “3”. An editing operation is performed so that all audio signals contained in the moving picture mail can be transmitted.

The second mobile terminal 120 repeatedly checks an amount of data accumulated in the buffer every preset time and transmits the reception state message shown in FIG. 10. In response to the reception state message, the moving picture mail server 180 adjusts the transmission rate of moving picture mail to be transmitted according to a procedure shown in FIGS. 8A and 8B and then transmits the moving picture mail at the adjusted transmission rate.

The above-described operations are repeatedly performed before the moving picture mail server 180 terminates a transmission operation for the moving picture mail.

When the first mobile terminal 110 transmits the moving picture mail to the second mobile terminal 120 in accordance with the embodiment of the present invention, a transcoding operation is performed and a result of the transcoding operation is transmitted if the support codecs of the two mobile terminals are different. The moving picture mail is transmitted in a streaming manner so that the second mobile terminal 120 can stably display the moving picture mail.

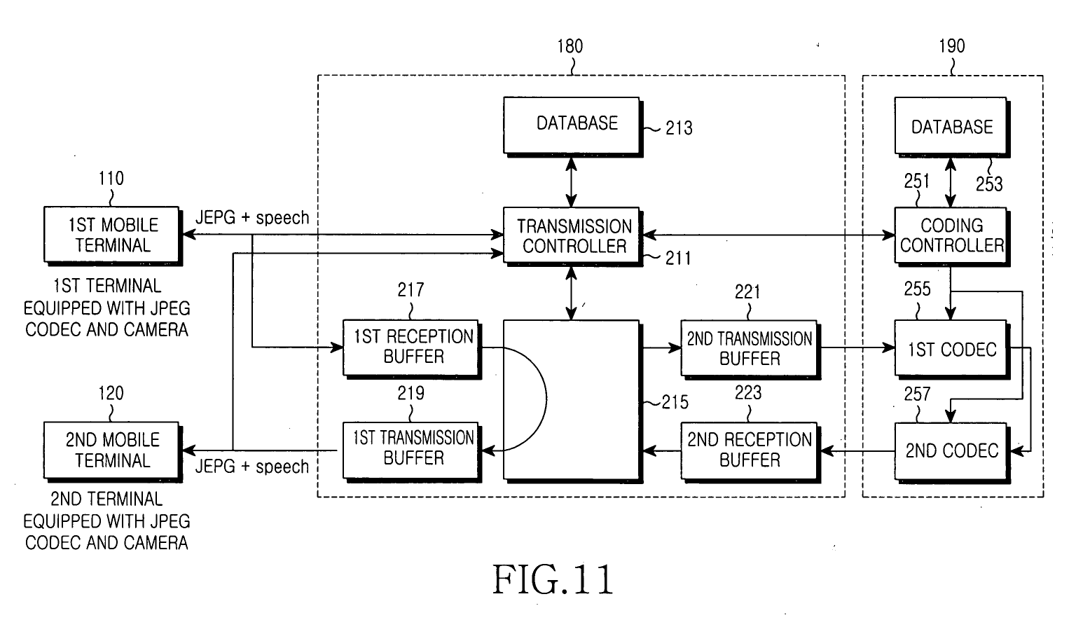

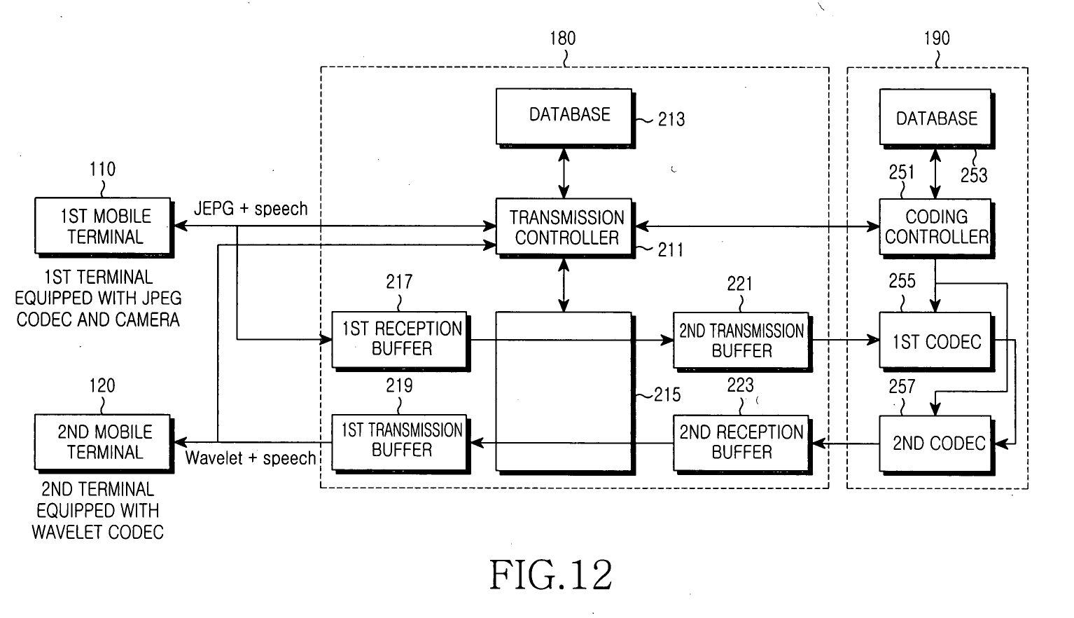

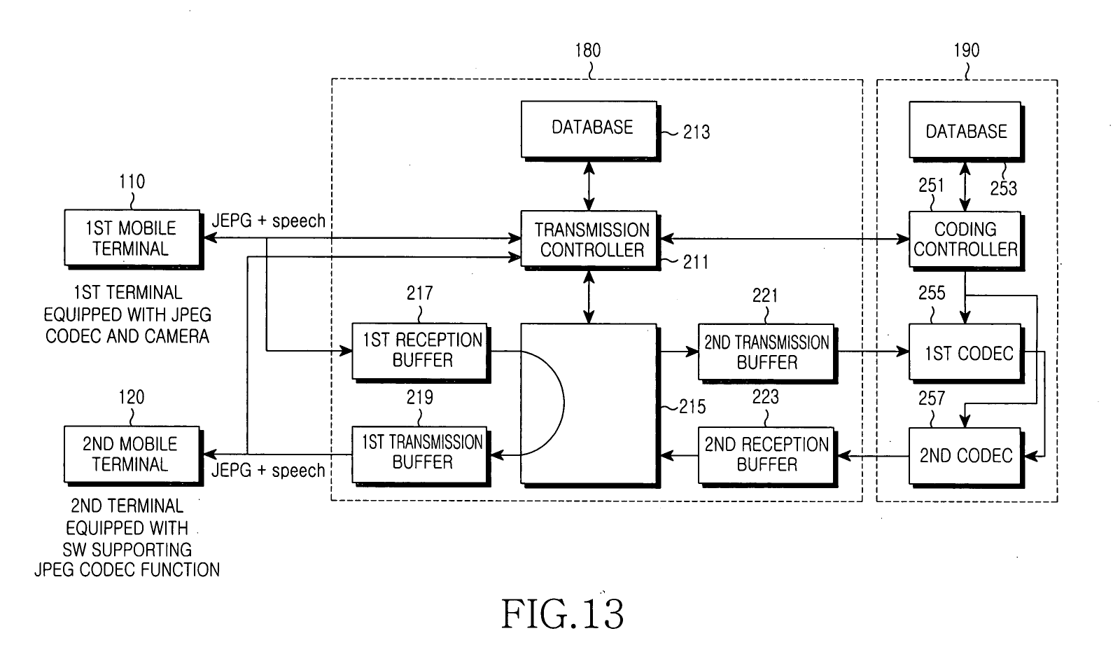

FIG. 11 is a block diagram illustrating an operation for enabling the moving picture mail server to transmit moving picture mail from one mobile terminal equipped with the first codec to the other mobile terminal equipped with the first codec in accordance with an embodiment of the present invention. FIG. 12 is a block diagram illustrating an operation for enabling the moving picture mail server to transmit moving picture mail from one mobile terminal equipped with the first codec to the other mobile terminal equipped with the second codec in accordance with an embodiment of the present invention. FIG. 13 is a block diagram illustrating an operation for enabling the moving picture mail server to transmit moving picture mail from one mobile terminal equipped with the first codec to the other mobile terminal equipped with software supporting a function of the first codec in accordance with another embodiment of the present invention. Here, it is assumed that the first codec is a JPEG codec and the second codec is a wavelet codec. Further, it is assumed that the moving picture mail is a semi-moving picture signal and also a signal in which image signals are combined with audio signals. Furthermore, it is assumed that the first mobile terminal 110 includes the JPEG codec.

Referring to FIG. 11, when transmitting moving picture mail (JPEG+speech), the first mobile terminal 110 transmits information of the second mobile terminal 120 being the destination terminal to the moving picture mail server 180 and then transmits the moving picture mail. Then, the transmission controller 211 of the moving picture mail server 180 confirms a support codec of the second mobile terminal from the database 213, and controls the switch 215 to connect the first reception buffer 217 to the first transmission buffer 219. That is, because the first and second mobile terminals 110 and 120 support the same JPEG codec as shown in FIG. 11, the transmission controller 211 controls the switch 215 and controls a path so that the first reception buffer 217 can be connected to the first transmission buffer 219. Then, the moving picture mail from the first mobile terminal 110 is transmitted to the second mobile terminal 120 through the first reception buffer 217, the switch 215 and the first transmission buffer 219.

Referring to FIG. 12, when transmitting the moving picture mail (JPEG+speech), the first mobile terminal 110 transmits information of the second mobile terminal 120 being the destination terminal to the moving picture mail server 180 and then transmits the moving picture mail. Then, the transmission controller 211 of the moving picture mail sever 180 confirms a support codec of the second mobile terminal 120 from the database 213. Here, the first mobile terminal 110 supports the JPEG codec and the second mobile terminal 120 supports the wavelet codec. Thus, because the support codecs of the two mobile terminals are different, the transcoding server 190 must be used. The transmission controller 211 notifies the transcoding server 190 of support codec information of the second mobile terminal 120, and controls the switch 215 so that the first reception buffer 217 and the second reception buffer 223 can be connected to the second transmission buffer 223 and the first transmission buffer 219, respectively. The moving picture mail transmitted from the first mobile terminal 110 is applied to the transcoding server 190 through the first reception buffer 217, the switch 215 and the second transmission buffer 221. The transcoding server 190 transcodes the JPEG coded moving picture mail into a wavelet coded moving picture mail, such that the transcoded moving picture mail is transmitted to the second mobile terminal 120 through the second reception buffer 223, the switch 215 and the first transmission buffer 219.

Referring to FIG. 13, when transmitting the moving picture mail (JPEG+speech), the first mobile terminal 110 transmits information of the second mobile terminal 120 being the destination terminal to the moving picture mail server 180 and then transmits the moving picture mail. Then, the transmission controller 211 of the moving picture mail sever 180 confirms a support codec of the second mobile terminal 120 from the database 213. Here, it can be found that the second mobile terminal 120 is not equipped with the JPEG codec, but is equipped with software supporting a function of the JPEG codec. Then, the transmission controller 211 of the moving picture mail server 180 controls the switch 215 to connect the first reception buffer 217 to the first transmission buffer 219. That is, because the first and second mobile terminals 110 and 120 support the same JPEG codec function as shown in FIG. 11, the transmission controller 211 controls the switch 215 and controls a path so that the first reception buffer 217 can be connected to the first transmission buffer 219. Then, the moving picture mail from the first mobile terminal 110 is transmitted to the second mobile terminal 120 through the first reception buffer 217, the switch 215 and the first transmission buffer 219.

In accordance with the embodiment of the present invention, supportable codecs provided in mobile terminals of receiving and transmitting sides are checked when moving picture mail is transmitted, and a transcoding operation for the moving picture mail to be transmitted is performed when the mobile terminals support the different codecs, such that the moving picture mail can be appropriately transmitted between the mobile terminals equipped with the different codecs. Furthermore, a moving picture mail server transmits moving picture mail to a mobile terminal in a streaming manner, and the moving picture mail server adjusts an amount of data to be transmitted on the basis of a preset method in response to reception state information transmitted from the mobile terminal at a predetermined time interval, such that a cut-off phenomenon of a moving picture signal to be reproduced in the mobile terminal can be compensated for.

Although the embodiments of the present invention have been disclosed for illustrative purposes, those skilled in the art will appreciate that various modifications, additions and substitutions are possible, without departing from the scope of the invention.

What is claimed is:

1. A method for enabling a moving picture mail server to receive moving picture mail from a first mobile terminal and transmit the received moving picture mail to the second mobile terminal, comprising the steps of:
(a) confirming a support codec of the first mobile terminal serving as a transmitting side;
(b) confirming a support codec of the second mobile terminal serving as a receiving side;
(c) determining whether or not the support codecs of the first and second mobile terminals are compatible;
(d) if the support codecs of the first and second mobile terminals are compatible, transmitting the moving picture mail received from the first mobile terminal to the second mobile terminal;
(e) if the support codecs of the first and second mobile terminals are incompatible, transcoding the moving picture mail received from the first mobile terminal on the basis of the support codec of the second mobile terminal; and
(f) transmitting the transcoded moving picture mail to the second mobile terminal.

2. The method as set forth in claim 1, wherein the step (e) further comprises the steps of:
selecting a first codec corresponding to the support codec of the first mobile terminal and a second codec corresponding to the support codec of the second mobile terminal;
decoding the moving picture mail received from the first mobile terminal by means of the selected first codec; and
coding the decoded moving picture mail by means of the selected second codec.

3. The method as set forth in claim 2, wherein the first codec comprises a Joint Photographic Expert Group (JPEG) codec and the second codec comprises a wavelet codec.

4. The method as set forth in claim 2, wherein the step (a) further comprises the steps of:
receiving a moving-picture mail transmission notification message from the first mobile terminal; and
confirming the first mobile terminal's support codec information included in the moving-picture mail transmission notification message, and
wherein the step (b) further comprises the steps of:
notifying the second mobile terminal of the fact that the moving picture mail has arrived; and
receiving a response message from the second mobile terminal, and confirming the second mobile terminal's support codec information included in the response message.

5. The method as set forth in claim 2, wherein the step of transmitting the moving picture mail from the moving picture mail server to the second mobile terminal further comprises the steps of:
when the second mobile terminal requests that the moving picture mail be transmitted, transmitting the moving picture mail at a preset transmission rate; and
checking buffering information of the moving picture mail fed from the second mobile terminal, newly setting the transmission rate according to a change of the buffering information, editing the moving picture mail according to the newly set transmission rate, and performing a transmission operation.

6. The method as set forth in claim 5, wherein the step of newly setting the transmission rate comprises the step of:
confirming a new transmission rate based upon the buffering information transmitted from the second mobile terminal through a transmission rate change table and setting the confirmed new transmission rate, the moving picture mail server including the transmission rate change table corresponding to the buffering information.

7. The method as set forth in claim 6, wherein the step of editing the moving picture mail according to the newly set transmission rate further comprises the step of:
performing an editing operation by reducing a size of an image frame according to the newly set transmission rate so that image data can be reproduced in real time.

8. The method as set forth in claim 5, wherein the step of allowing the second mobile terminal to generate the buffering information further comprises the steps of:
receiving the moving picture mail from the moving picture mail server, storing the received moving picture mail in a buffer, reproducing data of the received moving picture mail, and buffering other data of the received moving picture mail when an amount of data accumulated in the buffer has reached a predetermined size or more;
allowing the second mobile terminal to generate buffering information based upon the amount of data accumulated in the buffer at a predetermined time interval and to transmit the buffering information to the moving picture mail server; and
repeatedly performing an operation for receiving moving picture mail from the moving picture mail server according to a newly set transmission rate based upon the buffering information, storing the moving picture mail in the buffer, and reproducing the moving picture mail.

9. The method as set forth in claim 8, wherein the step of generating the buffering information further comprises the steps of:
checking the amount of data accumulated in the buffer at a predetermined time; and
deciding the buffering information according to the amount of data accumulated in the buffer and transmitting the determined buffering information to the moving picture mail server.

10. An apparatus for communicating moving picture mail, comprising:
a first mobile terminal equipped with a first codec for transmitting moving picture mail coded by the first codec;
a second mobile terminal equipped with a second codec for decoding received moving picture mail by the second codec;
a moving picture mail server comprising:
a database for storing codec information of the first and second mobile terminals;
a transmission controller for confirming support codecs of the first and second mobile terminals to output codec information and generating a path control signal of the moving picture mail on the basis of the codec information; and
a switch for setting a first path for receiving the moving picture mail from the first mobile terminal and a second path for outputting the moving picture mail to the second mobile terminal, according to the path control signal; and a transcoding server comprising:
a coding controller for generating a selection control signal for selecting a first codec corresponding to the first mobile terminal and a second codec corresponding to the second mobile terminal according to the codec information output from the transmission controller;
the first codec selected by the coding controller, the first codec decoding the moving picture mail received from the first mobile terminal through the first path; and
the second codec for performing a transcoding operation by coding the moving picture mail so that the second mobile terminal can decode the coded moving picture mail and outputting a result of the transcoding operation to the second path.

11. The apparatus as set forth in claim 10, wherein the first codec comprises a Joint Photographic Expert Group (JPEG) codec.

12. The apparatus as set forth in claim 10, wherein the second codec comprises a wavelet codec.
